(19) United States
(12) Patent Application Publication
(10) Pub. No.: US 2002/0070274 A1
(43) Pub. Date: Jun. 13, 2002

(54) IC card reading connector

(76) Inventor: Tien-Tsai Lee, Taipei Hsien (TW)

Correspondence Address: BACON & THOMAS, FOURTH FLOOR, 625 SLATERS LANE, ALEXANDRIA, VA, 22314, US

(21) Appl. No.: 09/732,736

(22) Filed: Dec. 11, 2000

(51) Int. Cl. G06K 7/06; G06K 19/00

(52) U.S. Cl. 235/441

(57) ABSTRACT

An IC card reading connector having a body is disclosed. The body has an IC card slot. The IC card slot has a movable flat block. A distal end of the movable flat block has an IC card holding plate. A rear side of the IC card holding plate is resisted against by a spring. A lower side of the IC card holding plate is installed with a positioning roller. When the IC card is inserted, the positioning roller is embedded into a receiving hole, then a reaction force is applied to the movable flat block, and then a reaction force is further applied to the positioning roller. By the confining of the receiving hole, the positioning roller and the IC card holding plate serve to hole the IC card. A bottom of the positioning roller has a receiving hole at a rear side of the body; a surface of the movable flat block being installed with a plurality of trenches; each trench being installed with a terminal; and a portion at the trench being in contact with a front end of the terminal having an inclined guide surface. The inclined guide surface pushes the terminals to move upwards and downwards so as to contact the chip in the IC card.

### FIELD OF THE INVENTION

The present invention relates to an IC card reading connector, wherein the IC card can be held steadily and is prevented to the scratched so as to prolong the lifetime of an IC card so that the data can be read accurately. The cost in maintenance is reduced.

### BACKGROUND OF THE INVENTION

With the progress of technology, IC cards are more and more popular, and more and more widely, such as credit card, phone cards, even the patient history cards, certificate cards, etc. Therefore, many card readers are designed for reading data in the IC cards. The IC card is inserted into a card reader for reading data therein and then various transactions are performed.

In the aforesaid method, an IC card reading connector is necessary for reading data in the IC card. In the prior art, the IC card reader has an IC card slot. Terminals are installed in the slots. When the IC card is inserted, at first, the terminals are depressed, after the IC card is attained to a predetermined position, the terminals will restores by elasticity to the surface of the IC card, and the terminal exactly resists against the surface of the chip of the IC card.

However, this prior art design has the following disadvantages:

1. As the IC card is inserted into the reader, the IC card reading connector will rub with the terminals so that the surface of the IC card is worn, even the chip is destroyed so that the IC card loses of function. Furthermore, under the action of the friction for a long period of time, the plating layer on the surface of the terminal will be worn out so that the impedance is increased and the data can not be read out successfully.

2. The prior art IC card reading connector, the IC card slot is clamped by a simple clamping piece, if the clamping force is insufficient, then work can not be performed conveniently, and further the wearing of the terminals, faults occurs frequently in reading data from the IC card.

### SUMMARY OF THE INVENTION

Accordingly, the primary object of the present invention is to provide an IC card reading connector. In general, the terminals are embedded below the IC card slot, as the IC card is inserted, then the terminals protrude to contact the chip. Therefore, the IC card slot and chip will not be scratched, and the user is convenient.

Another object of the present invention is to provide an IC card reading connector, wherein the positioning roller and the IC card holding plate serve to hole the IC card, the force is large so that the reading of the IC card is steady.

A further object of the present invention is to prolong the lifetime of an IC card so that the data can be read accurately. The cost in maintenance is reduced.

The various objects and advantages of the present invention will be more readily understood from the following detailed description when read in conjunction with the appended drawing.

### BRIEF DESCRIPTION OF THE DRAWINGS

FIG. 1 is a perspective view of the IC card reading connector according to the present invention.

FIG. 2 is an exploded perspective view of the IC card reading connector in the present invention.

FIG. 3A is a schematic view of the IC card reading connector before inserting.

FIG. 3B is a view along A-A′ of FIG. 3A.

FIG. 4A is a schematic view of the IC card reading connector after inserting.

FIG. 4B is a view along B-B′ of FIG. 4A.

FIG. 5A is a schematic view showing the action of terminals of the IC card reading connector before inserting.

FIG. 5B is a schematic view showing the action of terminals of the IC card reading connector after inserting.

FIG. 6A shows the installation of the dust-proof cover of the IC card reading connector according to the present invention.

FIG. 6B shows the operation of the dust-proof cover of the IC card reading connector according to the present invention.

### DETAILED DESCRIPTION OF THE PREFERRED EMBODIMENTS

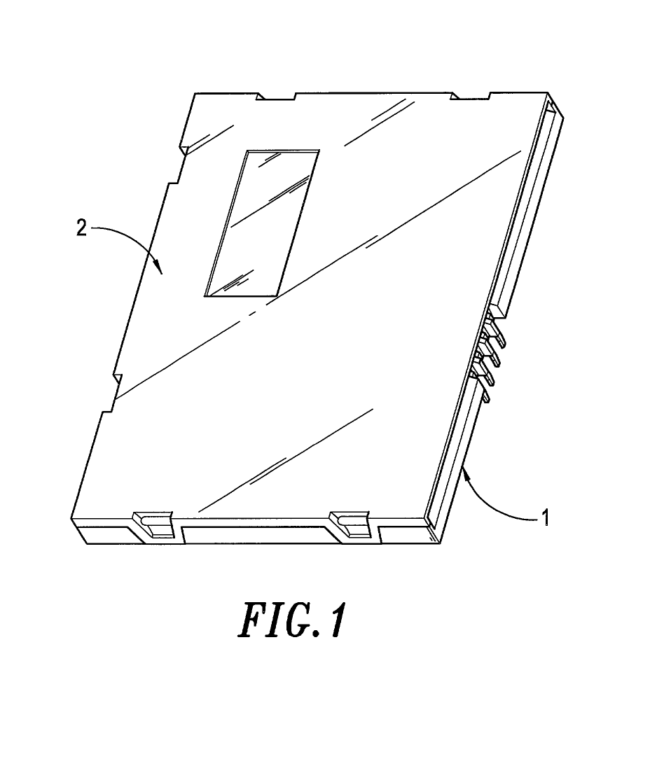

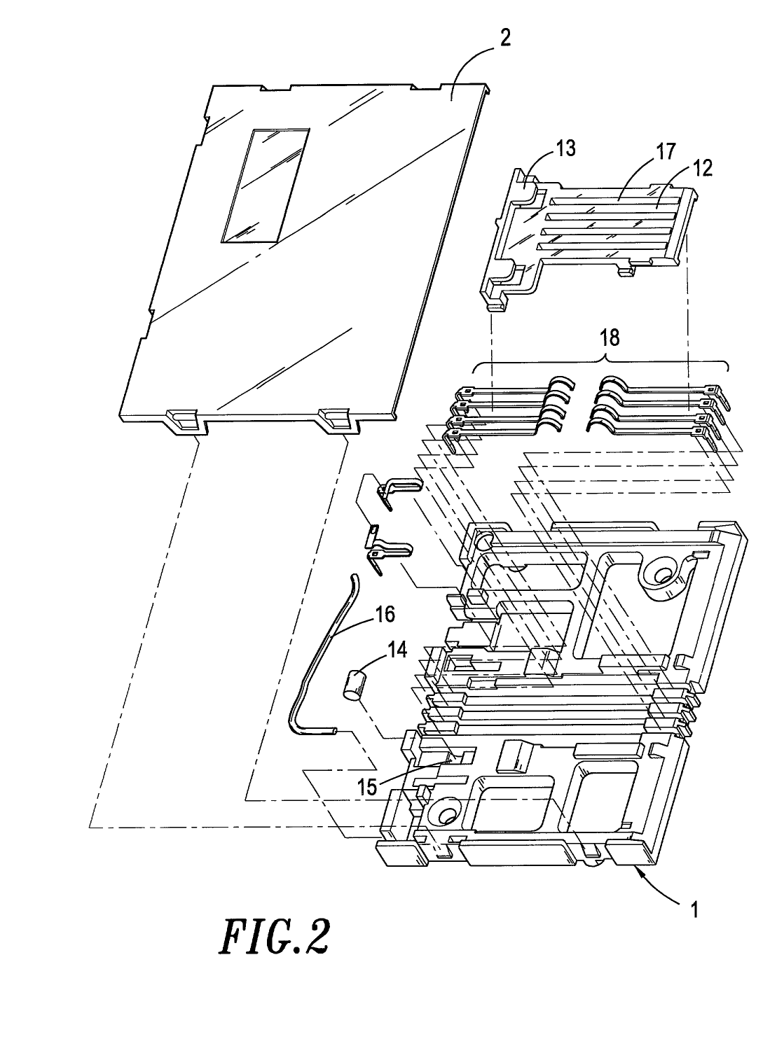

Referring to FIGS. 1 and 2, the IC card reading connector of the present invention is illustrated. The IC card reading connector is formed by a body 1 and upper cover 2. The body has an IC card slot 11. The IC card slot I1 has a movable flat block 12 at the surface thereof. The distal end of the movable flat block 12 has an IC card holding plate 13. The lower side of the IC card holding plate 13 is installed with a positioning roller 14. The bottom of the positioning roller 14 has a receiving hole 15 at the rear side of the body 14. The rear side of the IC card holding plate 13 is resisted against by a spring 16. The surface of the movable flat block 12 is installed with a plurality of trenches 17. Each trench 17 is installed with a terminal 18. The tail portion of the terminal 18 extends to the body 1 for being connected to other information processing device (not shown). The portion at The trench 17 being in contact with a front end of the terminal 18 has an inclined guide surface 19.

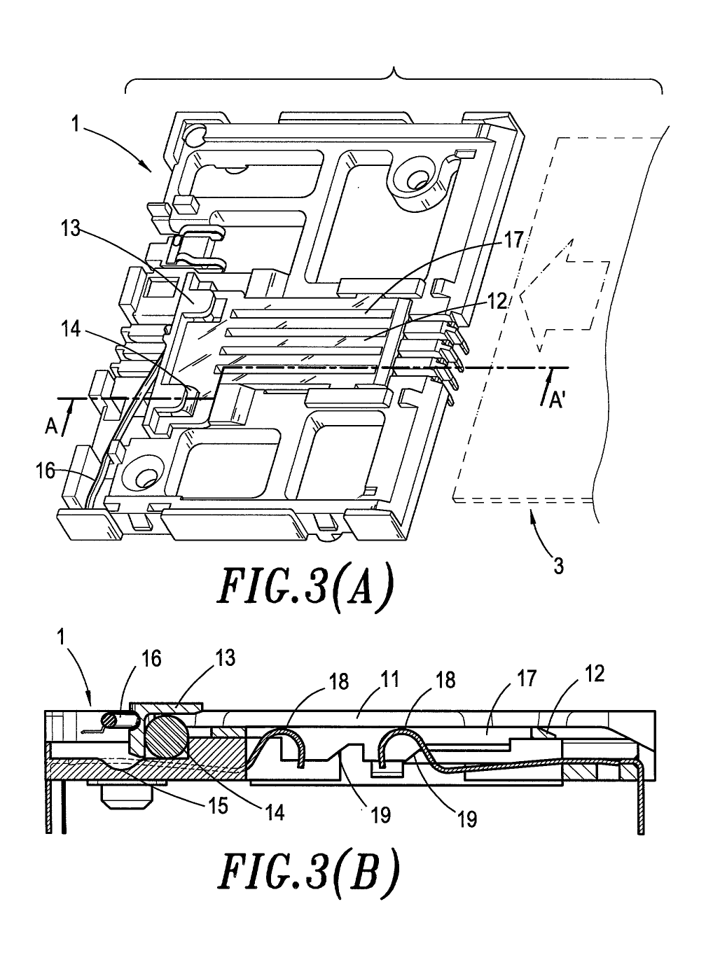

Referring to FIGS. 3A and 3B, in general, the movable flat block 12 is resisted at a fixed position by the spring 16 which is a strip spring and has a distal end being fixed to the body 1 for generating a force to push the movable flat block 12. Then, the terminal 18 is embedded into the trench 17 of the movable flat block 12.

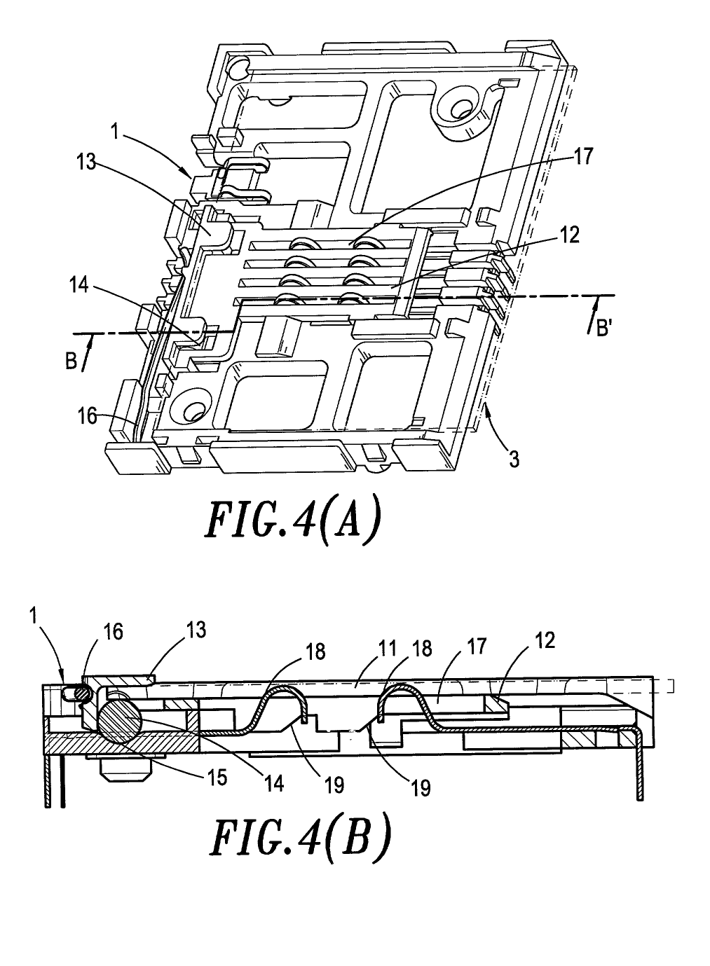

Referring to FIGS. 4A and 4B, when the IC card 3 (dashed line) is inserted into the IC card slot 11, the front end of the IC card 3 will at first resist against the positioning roller 14 to slide backwards. The positioning roller 14 is rolling balls or rolling wheel and is embedded into the movable flat block for confining the rolling path of the movable flat block 12, and then drives the whole movable flat block 12 to move backwards. After the positioning roller 14 is received in the receiving hole 15, the IC card 3 is exactly held between the IC card holding plate 13 and the positioning roller 14. After the IC card 3 is fixed, the terminal 18 protrudes to resist against the chip of the IC card 3 for reading data. On the contrary, as the IC card 3 is drew out, the positioning roller 14 has no depressing force, the movable flat block 12 and the positioning roller 14 will restore to the original position by the resilient force of the spring 16. Then, the terminal 18 is again embedded into the trench 17 for preventing to scratch the IC card 3.

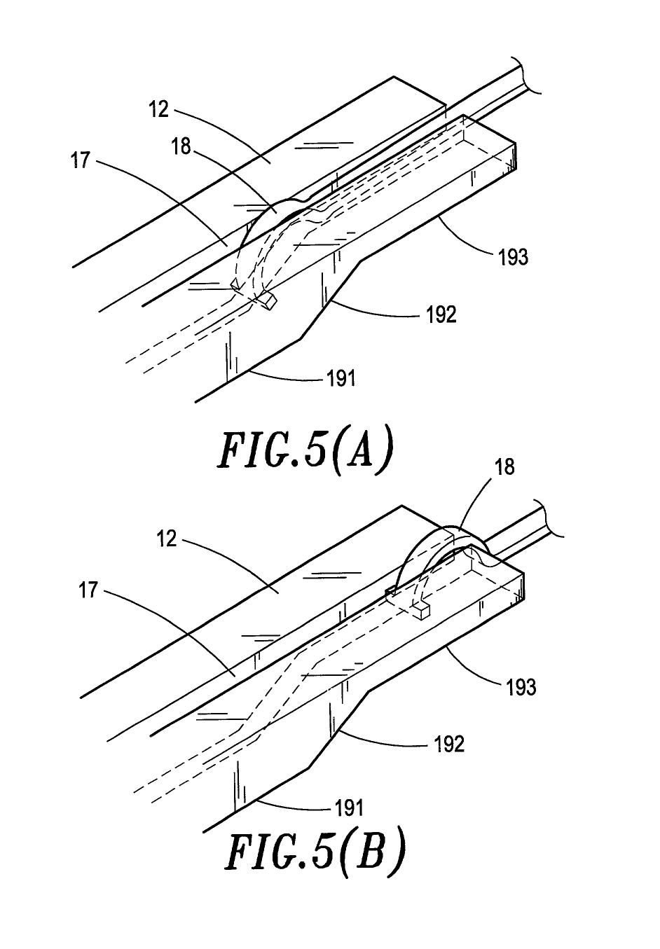

Referring to FIGS. 5A and 5B, the inclined guide surface 19 has two different heights which are connected by a tilt surface 192. The terminal 18 is elastic and a front end thereof is at the lower guide surface 191 so that the terminal 18 can be embedded into the trench 17. When the IC card 3 is inserted therein, the movable flat block 12 slides backwards, then the front end of the terminal 18 moves to a higher guide surface 193 through the tilt surface 192. Therefore, the terminal 18 protrudes out of the trench 17 to be in contact with the chip and thus, the terminal 18 will not rub with the IC card 3.

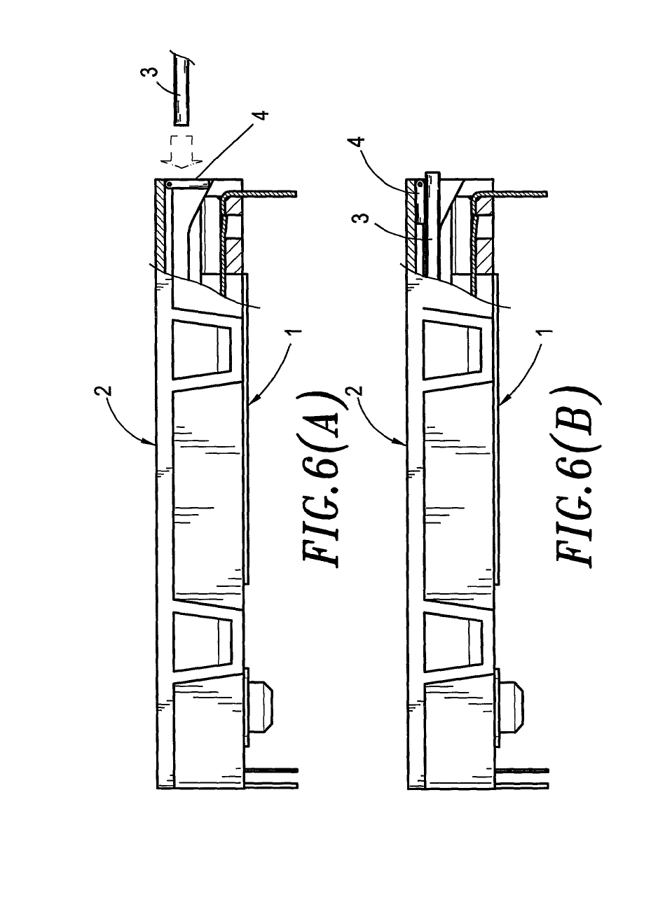

With reference to FIGS. 6A, and 6B, in the present invention, a dust-proof cover 4 can be installed at the opening for inserting the IC card 3 into the IC card slot 11 for preventing dusts or objects from falling into the IC card slot 11 and thus the lifetime of the product is increased.

Comparing with the prior art designs, the IC card reading connector of the the present invention has the following advantages:

1. The terminals of the present invention will not rub with the IC card, the IC card will not be destroyed and the correction of reading increased. Fault is reduced.

2. The reading speed of IC card is increased. In the supermarkets or large markets, the waiting time of the consumer is reduced. The time required is reduced.

3. The lifetime of the product is increased and the maintenance and updating cost is decreased. Moreover, the task can be performed easily.

4. The IC card can be held steadily and does not fall down. The reading of data is correct.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An IC card reading connector having a body; the body having an IC card slot; the IC card slot having a movable flat block; a distal end of the movable flat block having an IC card holding plate; a rear side of the IC card holding plate being resisted against by a spring; a lower side of the IC card holding plate being installed with a positioning roller; a bottom of the positioning roller having a receiving hole at a rear side of the body; a surface of the movable flat block being installed with a plurality of trenches; each trench being installed with a terminal; and a portion at the trench being in contact with a front end of the terminal having an inclined guide surface.

2. The IC card reading connector as claimed in claim 1, wherein positions and amounts of the trenches and terminals are dependent on the IC card and distribution of chips.

3. The IC card reading connector as claimed in claim 1, wherein the spring is a plate shape spring, one end thereof is fixed to the body, while another end thereof resists against a rear side of the IC card holding plate for generating a push force to control the movement of the movable flat block.

4. The IC card reading connector as claimed in claim 1, wherein the positioning roller is rolling balls or rolling wheels and is embedded into the movable flat block for confining the rolling path of the movable flat block, thus, the positioning roller moves through the receiving holes easily.

5. The IC card reading connector as claimed in claim 1, wherein a dust-proof cover is installed at an opening for inserting the IC card into the IC card slot for retaining the cleanness of the IC card slot.
